(19) United States
(12) Patent Application Publication
(10) Pub. No.: US 2009/0242745 A1
(43) Pub. Date: Oct. 1, 2009

(54) Method for Detecting of Geotectonic Signals Triggered by a Geotectonic Event

(75) Inventors: Michael Bittner, Untermühlhausen (DE); Kathrin Höppner, Starnberg-Perchting (DE); Sabine Wüst, Eckental (DE)

Correspondence Address: COLLARD & ROE, P.C., 1077 NORTHERN BOULEVARD, ROSLYN, NY, 11576, US

(73) Assignee: Deutsches Zentrum für Luft-und Raumfahrt e.V., Köln (DE)

(21) Appl. No.: 12/084,266

(22) PCT Filed: Nov. 2, 2006
(86) PCT No.: PCT/EP2006/010520

§ 371 Date: Apr. 29, 2008

(30) Foreign Application Priority Data
Nov. 4, 2005 (DE) 10 2005 053 038.9

(51) Int. Cl. G01V 1/00

(52) U.S. Cl. 250/253

(57) ABSTRACT

For the detection of geotectonic signals triggered by a geotectonic event, an infrasonic wave accompanying the geotectonic event and being generated at the ground and temperature fluctuations are utilized, causing a modulation of an airglow. The modulation of the airglow is detected from the ground by means of an infrared spectrometer and the mesopause temperature is measured with a high temporal resolution. For the detection of a geostationary event, a number of simultaneously operated infrared spectrometers is provided in regions sensitive to geotectonic events.

### FIELD OF THE INVENTION

The invention is directed to a method for detecting geotectonic signals triggered by a geotectonic event, utilizing an infrasonic wave accompanying the geotectonic event and being generated at the ground, and further utilizing temperature fluctuations causing a modulation of an airglow, said temperature fluctuations being caused by said infrasonic wave whose amplitude increases with the altitude due to the exponentially decreasing air pressure.

### BACKGROUND OF THE INVENTION

On Christmas 2004, a tsunami released by a seaquake caused a natural disaster along the shores of littoral states of the Indian Ocean, taking the lives of almost 250,000 humans. This event stirred reflections around the world to install and develop efficient alarm systems that assist in an early detection of such events and thus allow the population to be warned in time.

### DESCRIPTION OF STATE OF THE ART

Instruments previously used to record geotectonic signals include:
seismographs for recording seismic signals,
sub-aqueous pressure sensors for recording minute seismic signals and irregularities of pressure,
GPS supported measuring buoys for observing the sea level in the event of a seaquake,
microbarographs for measuring infrasonic waves developed and employed to control the nuclear weapons non-proliferation treaty of 1996.

However, the seismic systems used hitherto can not discriminate whether the ground shifts in the horizontal or the vertical direction. However, tsunamis, for example, exclusively form when the ground is lifted vertically.

The previously employed pressure sensors are merely configured for the detection of earthquakes and tsunamis. Existing instruments, such as the GPS supported measuring buoys, require intensive maintenance.

### SUMMARY OF THE INVENTION

It is an object of the present invention to provide a highly efficient method for detecting geotectonic signals, wherein the direction of a shift is detected utilizing an infrasonic wave accompanying a geotectonic event.

According to the characterizing part of claim 1, the method of the present invention achieves this object by detecting a modulation of an airglow from the ground by means of an infrared spectrometer and by measuring the temperature of the mesopause with a high temporal resolution.

The present method profits from the fact that, as the altitude increases, the amplitude of an infrasonic wave generated at the ground becomes ever higher due to the exponentially decreasing air pressure. The fluctuations in temperature caused by such a wave effect a modulation of the so-called “airglow” at an altitude of 87 km. The so-called airglow is an emission of rotational-vibrational bands of the excited hydroxyl molecule (OH*) and oxygen molecule (O₂*) from the altitude range of approximately 85-95 km in the infrared and visible wavelength range.

According to the invention, such an airglow is measured at night from the ground with a high temporal resolution in the order of 1-3 minutes using infrared spectrometers. The information thus obtained is of essential importance, for example with respect to the development of tsunamis and thus to an early warning.

Yet, the present method is not restricted to the detection of seaquakes and their relevance for the development of a tsunami. Although geotectonic signals are caused in particular by vertically oriented earthquakes, such as seaquakes, geotectonic signals may also be generated by volcanic activity, explosions, storms, meteorites entering the atmosphere, or wind power plants. The present method is thus generally suited for operative infrasonic detection and thus for recording geotectonic signals within the framework of an early warning system.

In an advantageous development of the invention, a network of a number of simultaneously operated infrared spectrometers may be set up, the infrared spectrometers being installed in sensitive regions, thereby allowing to locate the respective geotectonic event.

### DESCRIPTION OF THE DRAWINGS

In the Figures:

FIG. 1 is a schematic illustration of a sound wave in a tube;

FIG. 2 is another schematic illustration of an infrasonic measuring station comprising a microbarograph sunk into the ground;

FIG. 3 is a picture from aboard a satellite showing a layer of excited hydroxyl molecules (OH*) at an altitude of about 87 km, and

FIG. 4 shows the temporal development of the temperature in the region of the mesopause at an altitude of about 87 km, measured with an infrared spectrometer.

### DETAILED DESCRIPTION OF PREFERRED EMBODIMENTS

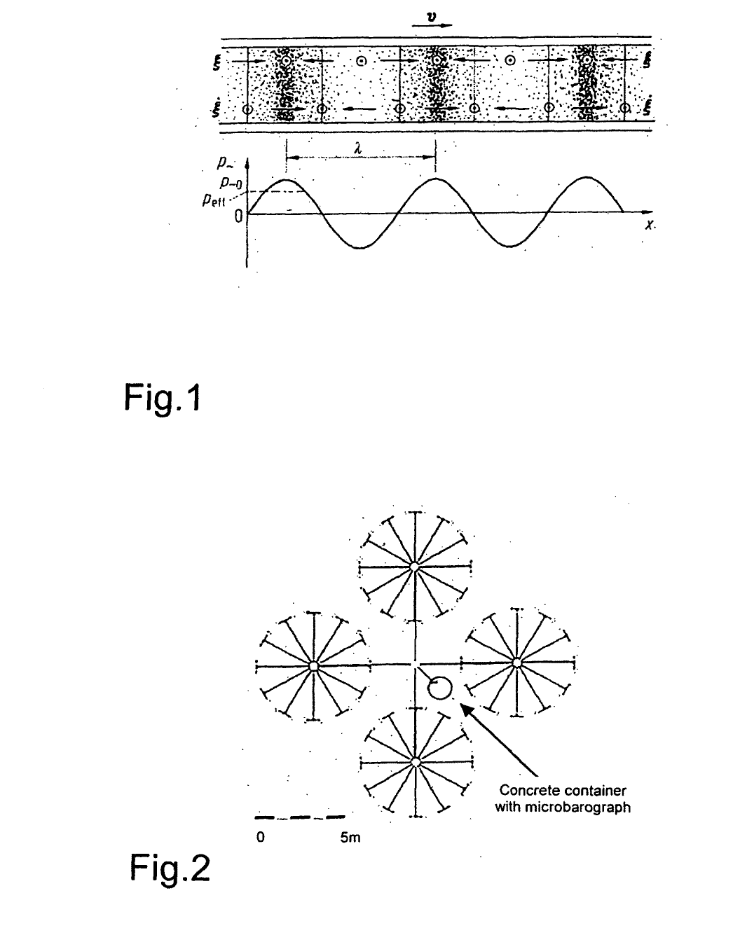

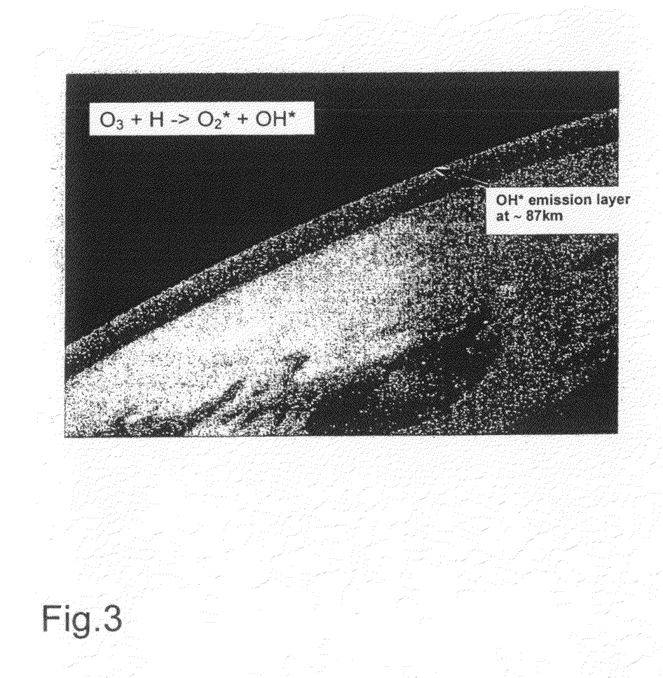

Since sound waves are mechanical density waves, compression portions propagate periodically in longitudinal direction, as can be seen in the schematic illustration in FIG. 1. At frequencies below 15-20 Hz, infrasound is not perceptible by human hearing that is in the range between 16 Hz to 20 kHz. The oscillation period is between about 5 minutes and 0.1 seconds, the wavelength is between about 1000 km and 30 m. Since such waves are absorbed only very weakly in the atmosphere, they can propagate over large distances.

In the early 60's, nuclear weapon tests were monitored using infrasound. As the number of such tests has decreased, especially due to the ban on nuclear weapons tests above ground, the public infrasonic research has subsided. However, one may assume that infrasonic research has been carried on at least in the military domain since there is a large variety of possible military applications, such as the use of infrasound as a weapon in the form of an infrasonic gun or as a means to locate engines, turbines and other rotating machines.

Besides oscillating bridges or skyscrapers, sounds of infrasound may also be storms, the surf and the tides of the sea, meteors entering the atmosphere, or volcanic eruptions. Wind power plants also produce infrasound. It is also possible, by frequency analysis, to conclude on the gas content of the rising magma from the infrasound coming from a volcano.

Infrasound may be measured directly with special microphones whose size, however, is a multiple of that of conventional microphones. The core piece is a highly sensitive microbarograph sunk into the ground and communicated with the atmosphere through a pipe system arranged in a star shape on the ground, as is schematically illustrated in FIG. 2. This two-dimensional arrangement reduces disturbing pressure variations as they are caused by turbulences of the airflow, e.g., by wind. Presently, a globally distributed infrasonic measuring network is in the making which will eventually comprise 60 stations.

Sound waves are longitudinal with periodically continuing density changes in a medium. Uplifts and drops of the land or sea level, for example, act like the membrane of a loudspeaker moving the molecules above this surface back and forth by a distance ξ, in time with the cycle of this vibration. The elasticity of the medium acts as the returning force; the disturbance propagates sinuously, as can be seen in FIG. 1. Since the air pressure decreases as the altitude increases, the amplitude of a sound wave increases with the altitude. Thus, a signal is clearly discernible at high altitudes in the atmosphere.

In the following, a rough estimation of the temperature change is made that is to be expected from a temperature change at higher altitudes in the atmosphere accompanying an infrasonic wave produced by a sea quake. It can be pointed out that the pressure change accompanying a sound wave is proportional to the gradient ξ in the propagation direction. This is given by:

$$Δ p ( x , t ) = \frac{1}{κ} {κξ}_{o} cos ( ω t - kx )$$

Here, x is the propagation direction of the wave,

$$ω = \frac{2 Π}{t}$$

is the angular frequency,

$$k = \frac{2 Π}{λ}$$

is the wave number, λ is the wavelength, k is the compressibility of the medium, and ξ₀ is a maximum deflection of the molecules.

Thus, the maximum pressure change is given as:

$$Δ {p}_{ma x} = \frac{1}{κ} {κξ}_{o}$$

This expression is generally applicable to all media if the corresponding compressibility k is used. Since pressure alternations in sound waves occur quickly depending on the thermal conductivity of air, the following is based on adiabatic processes. For such processes, the compressibility is given as:

$$k = \frac{1}{γ p} , \\ where$$

$$γ = \frac{{c}_{p}}{{c}_{v}}$$

γ is the ratio of the thermal capacities at constant pressure and volume and amounts to approximately 1.4 for air at a temperature of 300 Kelvin.

During the quake before Sumatra, within seconds the ground sank by ten meters over a distance of about 1,000 kilometers; the water level was lifted by about half a meter. For a first estimate, it is thus assumed that a seaquake entailed a change in the sea level of 0.5 meters (ξ₀). If the length of the infrasonic wave is given as λ=1,000 km and the air pressure at the sea level is assumed as p=1,013 hPa, then

$$Δ {p}_{ma x} = 1 , 4 \times 1013 \frac{2 π}{{10}^{6}} 0.5 \approx 4.46 \times {10}^{- 1} hPa$$

is obtained for the pressure change to be expected at the surface.

It is assumed that these conditions apply to an ideal gas. Thus, the following relation between pressure and temperature holds true:

$${TP}^{\frac{1}{γ} - 1} = const .$$

For a temperature of 300 K and a pressure of 1,013 hPa, a value of 41.53 is obtained for the constant. Thus, it can be estimated that the temperature change accompanying such an event is

$$Δ T = \frac{41 , 53}{{( 1013 + Δ p )}^{\frac{1}{γ} - 1}} - 300 \approx 9 , 1 \times {10}^{- 3} K$$

In this grossly simplifying and rough estimate, it is assumed that the infrasonic wave propagates vertically in the atmosphere with almost no loss (which naturally is not true). Up to an altitude of about 90 kilometers, the air pressure decreases by a factor of 10⁵ with respect to the surface level. This means that the above mentioned pressure change, related to one infrasonic wave at most, effectively, i.e. relative to sea level, is

Δp_{max/90km}≈446 hPa

Thus, an effective temperature change of ΔT≈33 K is obtained.

As already mentioned above, the estimate made here starts from grossly simplified conditions. In detail, the processes are a lot more complicated; damping processes, wave conduction phenomena etc. have not been considered here. Nevertheless, this estimate shows that infrasonic waves in the region of the upper mesosphere may presumably cause temperature variability in the order of several 10 K. Here, the periodicity should be within a range of up to several minutes.

Detecting infrasound-related signatures in the temperature of the upper mesosphere for an early detection of natural risks necessitates an operational, quality-assured and continuous monitoring thereof by means of robust infrared spectrometers. This takes advantage of the fact that a layer of excited hydroxyl molecules (OH*) exists in the altitude range of the mesopause. This layer has a vertical extension of approximately 7 kilometers; its center is at about 87 kilometers. Excited OH* molecules emit radiation in the near infrared in the range from 1.2 to 1.6 micrometers that correspond to different oscillation and rotation transitions of the molecule and can be measured by the instrument at night (“airglow”).

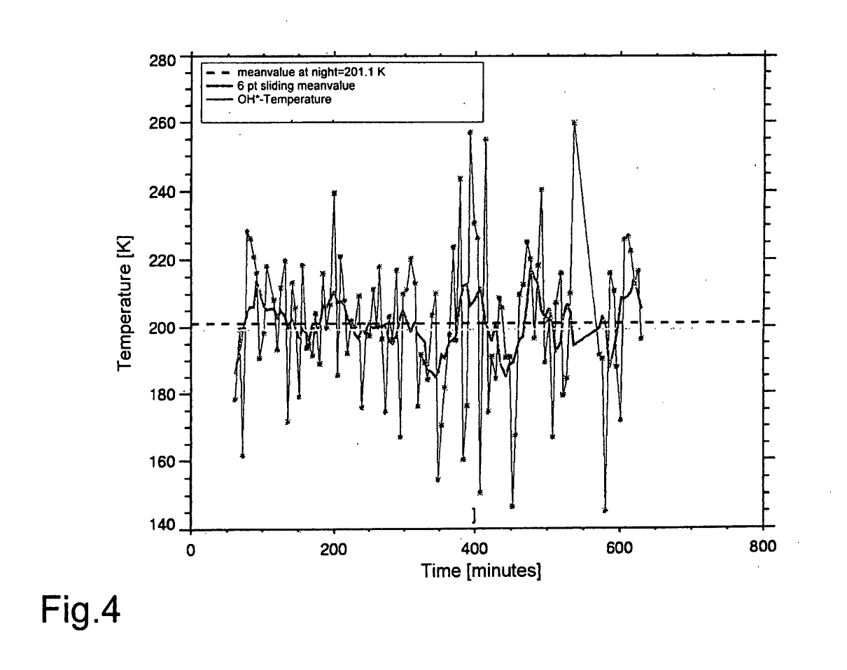

FIG. 4 shows a photo of this layer taken by the US satellite Clementine. The emissions from the rotation-vibration transitions of the OH* (3.1) bands can be detected by the above mentioned ground-bound infrared spectrometers. This method is proven, robust and supplies a measured temperature value every one to three minutes unless the range of vision is not entirely covered by clouds. Thus, the system is basically adapted to detect vibrations in the periodic time range of infrasonic waves.

An example of a temperature time sequence recorded during one night is illustrated in FIG. 4. The temporal resolution is 4.5 minutes. Longer-scale variations in the course of temperature can be observed (see the thicker curve in FIG. 4) that presumably are due to atmospheric gravity waves and tides. These longer-scaled variations are superposed by short-scaled temperature variations (see the curve marked by * in FIG. 4) having periodic times of only a few minutes. It should further be noted that the amplitude of this short-scaled variations can vary heavily with respect to time. These signatures could at least in part be caused by infrasound. The measures can be evaluated practically in near real-time; infrasonic signatures can be detected by high-performance spectral analysis methods.

FIG. 4 represents the temporal development of temperature in the region of the mesopause (about 87 km) measured with an infrared spectrometer. The temporal resolution of the measures is 4.5 minutes. The thicker curve represents a sliding mean value. Particular attention should be given to the increase in the amplitude of the short-scaled temperature variations around the 400^{th} minute that reaches 40 to 80 K.

1-2. (canceled)

3. A method for detecting a geotectonic event, such as seaquakes, especially tsunamis, wherein an infrasonic wave triggered by such a geotectonic event and having an amplitude increasing due to the air pressure decreasing exponentially as the altitude increases, causes temperature fluctuations resulting in an airglow modulation and thereby in an emission of OH* rotation-vibration bands in the infrared wavelength range in the upper mesosphere, wherein the airglow modulation is measured at night from the ground with a high temporal resolution, using an infrared spectrometer, whereby such geotectonic events can be detected early on.

4. Method of claim 3, wherein for the detection of a geostationary event, a number of simultaneously operated infrared spectrometers is provided in regions sensitive to geotectonic events.
